(19) United States
(12) Patent Application Publication
(10) Pub. No.: US 2010/0077664 A1
(43) Pub. Date: Apr. 1, 2010

(54) Garage door and door panel therefor

(76) Inventor: Torre Stensland, Lakewood, WA (US)

Correspondence Address: TORRE STENSLAND, 9123 FOREST AVE. SW, LAKEWOOD, WA, 98498, US

(21) Appl. No.: 12/586,586

(22) Filed: Sep. 23, 2009

Related U.S. Application Data
(60) Provisional application No. 61/194,502, filed on Sep. 26, 2008.

(51) Int. Cl. E05D 15/38; E05D 15/00; E06B 3/06

(52) U.S. Cl. 49/197; 160/181; 160/236

(57) ABSTRACT

A garage door panel has a frame and a one-piece front plate. The frame is made from a plurality of metal tubes. The metal tubes each have a rectangular cross-sectional shape and are adjoined in a manner providing the frame with a generally flat front surface and a generally flat rear surface and in a manner such that the tubes form a plurality of openings extending between the faces. The one-piece front plate is mounted on the frame at the front surface thereof and covers all of the openings. The front plate is made from a sheet of polymeric material and extends substantially beyond one of a top edge face of the frame and a bottom edge face of the frame.

### CROSS REFERENCE TO RELATED APPLICATIONS

This patent application claims priority from co-pending U.S. Provisional Patent Application Ser. No. 61/194,502, filed Sep. 26, 2008, entitled “Dent Proof Garage Door Panel/Dura Door”, having a common applicant herewith, and being incorporated herein in its entirety by reference.

### FIELD OF THE DISCLOSURE

The disclosures made herein relate generally to garage doors and, more particularly, to garage doors having a multi-panel construction.

### BACKGROUND

Various construction techniques for articulating multi-panel garage doors are well known. One example of such a known construction technique includes door panels made entirely from wood products (e.g., wood frame with particle board inserts). Another example of such a known construction technique includes door panels made entirely from metal products (e.g., formed steel sheetmetal panels with steel reinforcements). Still another example of such a known construction technique includes door panels having a standalone steel door (i.e., formed steel sheetmetal panels) with wood cladding for adding cosmetic appeal. A skilled person will likely be aware of other such known construction techniques.

Garage doors constructing in accordance with these and other known construction techniques are prone to one or more drawbacks that adversely affect their durability and performance. Door panels made entirely from wood are generally relatively heavy and are prone to sun damage/fading, rotting, insect infiltration, sagging and/or warping. Similarly, door panels that have wood cladding are prone to sun damage/fading, rotting, insect infiltration. Door panels made from steel sheetmetal are prone to denting and rusting.

Therefore, a garage door constructed in a manner that overcomes drawbacks associated with conventional garage door construction techniques would be advantageous, desirable and useful.

### SUMMARY OF THE DISCLOSURE

A garage door constructed in accordance with the present invention will overcome drawbacks associated with conventional garage door construction techniques. Unlike garage doors constructed in accordance with conventional construction techniques, a garage door constructing in accordance with the present invention will be relatively light and not prone to degradation resulting from conditions such as sun damage/fading, rotting, insect infiltration, sagging and/or warping, denting or rusting. As such, a garage door constructing in accordance with the present invention will exhibit enhanced durability and performance with respect to garage doors constructed in accordance with conventional construction techniques.

In one embodiment of the present invention, a garage door panel comprises a frame and a one-piece front plate. The frame is made from a plurality of tubes. The tubes are adjoined in a manner providing the frame with a generally flat front surface and a generally flat rear surface and in a manner such that the tubes form one or more openings extending between the faces. The one-piece front plate is mounted on the frame at the front surface thereof and covers the one or more openings.

In another embodiment of the present invention, a garage door panel comprises a frame and a one-piece front plate. The frame is made from a plurality of metal tubes. The metal tubes each have a rectangular cross-sectional shape and are adjoined in a manner providing the frame with a generally flat front surface and a generally flat rear surface and in a manner such that the tubes form a plurality of openings extending between the faces. The one-piece front plate is mounted on the frame at the front surface thereof and covers all of the openings. The front plate is made from a sheet of polymeric material and extends substantially beyond one of a top edge face of the frame and a bottom edge face of the frame.

In another embodiment of the present invention, a garage door comprises a plurality of door panels pivotably attached to each other in a manner allowing articulation of each one of the door panels with respect to an immediately adjacent other one of the door panels. Each one of the door panels comprises a frame and a one-piece front plate. The frame is made from a plurality of tubes adjoined in a manner providing the frame with a generally flat front surface and a generally flat rear surface and in a manner such that the tubes form one or more openings extending between the faces. The one-piece front plate of each door panel is mounted on the respective frame at the front surface thereof and covers the one or more opening of the respective frame.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a front perspective view showing an embodiment of a garage door configured in accordance with the present invention.

FIG. 2 is a rear perspective view of the garage door shown in FIG. 1.

FIG. 3 is a cross-sectional view taken along the line 3-3 in FIG. 1.

FIG. 4 is a cross-sectional view taken along the line 4-4 in FIG. 1.

FIG. 5 shown a door panel in accordance with the present invention having a layer of insulating material mounted thereon.

FIG. 6 shows a first embodiment of an insulation bracket in accordance with the present invention.

FIG. 7 shows a second embodiment of an insulation bracket in accordance with the present invention.

FIG. 8 is a front view showing an embodiment of a door plate configured in accordance with the present invention.

### DETAILED DESCRIPTION OF THE DRAWING FIGURES

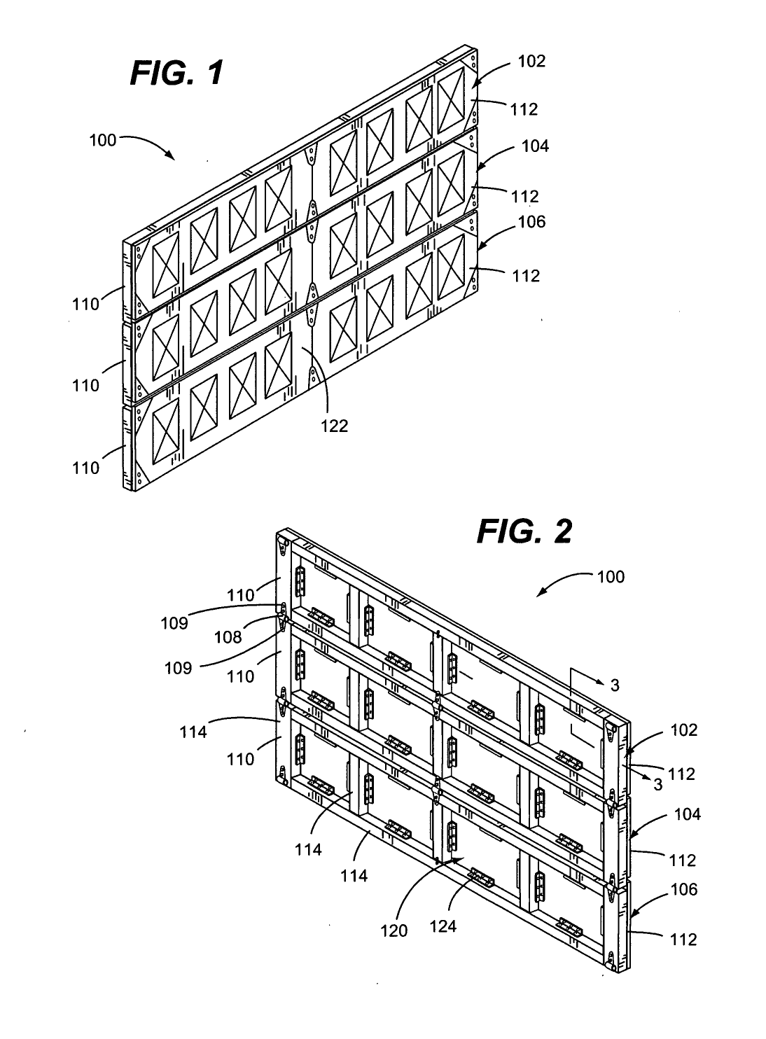

Referring to FIGS. 1-3, a garage door 100 constructed in accordance with an embodiment of the present invention is shown. The garage door 100 includes a plurality of garage door panels 102, 104, 106. The garage door panels 102, 104, 106 will be relatively light and not prone to degradation resulting from conditions such as sun damage/fading, rotting, insect infiltration, sagging and/or warping, denting or rusting. As such, the garage door 100 will exhibit enhanced durability and performance with respect to garage doors constructed in accordance with conventional construction techniques.

The garage door panels 102, 104, 106 are pivotably attached via hinge assemblies 108, thereby allowing articulation of each one of the door panels 102, 104, 106 with respect to an immediately adjacent other one of said door panels 102, 104, 106. It is disclosed herein that a garage door can include a single door panel, which is configured in accordance with the present invention. Accordingly, some garage doors configured in accordance with the present invention will include a plurality of door panel and some garage doors configured in accordance with the present invention will include a single door panel.

Each one of the door panels 102, 104, 106 includes a frame 110 and a front plate 112. The frame 110 is made from a plurality of tubes 114. The tubes 114 are adjoined in a manner providing the frame 110 with a generally flat front surface 116 and a generally flat rear surface 118 and in a manner such that the tubes 114 form a plurality of openings 120 extending between the face 116 and the rear surface 118. In the case where the tubes have a rectangular cross-sectional profile, the front surface 116 and the rear surfaces 118 of the frame 110 are defined by opposing exterior faces of each one of the tubes 114. Examples of such tubes include, but are not limited to steel tubes, aluminum, tubes, composite resin tubes and the like, which can be attached by means such as, for example, welding, chemical bonding, mechanical fasteners or the like. Preferably, each one of the tubes 114 has a rectangular cross-sectional profile (e.g., square).

Each one of the hinge assemblies 108 includes a pivotably attached hinge arms 109. Immediately adjacent ones of the door panels (e.g., door panels 102 and 104 and door panels 104 and 106) each have a plurality of hinge assemblies 108 coupled therebetween such that a first one of the hinge arms 109 of each one of the hinge assemblies 108 is engaged with the rear surface 118 of the frame 110 of a first immediately adjacent one of the door panels 102, 104, 106 and a second one of the hinge arms 109 of each one of the hinge assemblies 108 is engaged with the rear surface 118 of the frame 110 of a second immediately adjacent one of the door panels 102, 104, 106.

It is disclosed herein that the tubes 114 defining side edge portions of each door panel 102, 104, 106 can be wider than reinforcing tubes that extend between such side edge portion defining tubes. One benefit of such wider side edge portion tubes is that a wider tube provides more space for mounting a hinge assembly thereon (e.g., a width of the tube is approximately as wide as or is wider than a width of an associated hinge assembly).

The front plate 112 is mounted on the frame 110 at the front surface 116 thereof. Preferably, but not necessarily, the front plate 112 is a one-piece front plate front plate covers all of the openings 120 formed by the tubes 114. The front plate 112 can be attached to the frame 110 by numerous different techniques. In one preferred embodiment, for each one of an adjacent pair of the door panels 102, 104, 106, fasteners extend through each one of the hinge arms 109 engaged therewith, the respective frame 110 and the respective front plate 112 mounted on the respective frame 110. In one specific embodiment, a carriage bolt extends from a front surface 122 of the front plate 112 through the front plate 112, the frame 110 and the hinge arm 109.

As shown in FIGS. 2-4, each one of said door panels 102, 104, 106 can further include a plurality of plate securing brackets 124. The plate securing brackets 124 are attached to the tubes 114 of a respective frame 110 within one of the openings 120. Each one of the plate securing brackets 124 is engaged with a rear surface 126 of the front plate 112 of the respective door panel. One of more fasteners (e.g., threaded fasteners such as a screw) extend fully through each one of the plate securing brackets 124 and into the front plate 112, thereby securing the front plate 112 to the frame 110 via the plate securing brackets 124.

Preferably, but not necessarily, the door panels are configured in a manner for concealing a joint formed between frames 110 of adjacent ones of the door panels 102, 104, 106. Such concealing may be done for purposes of cosmetic appeal and/or creating a barrier to environmental elements (e.g., wind, rain, etc). In one embodiment, the front plate 112 of at least one of the door panel 102, 104, 106s extends substantially beyond a top edge face 128 of the frame 110 to which the front plate 112 is mounted or a bottom edge face 130 of the frame 110 to which the front plate 112 is mounted, thereby creating a ship lap between immediately adjacent ones of the door panels 102, 104, 106. In another embodiment, a piece of weather stripping can be provided between opposing edge faces 128, 130 of immediately adjacent ones of the door panels 102, 104, 106. In yet another embodiment, a protruding ridge can be provided in the exterior edge surface (e.g., top edge surface) of a first one of an immediately adjacent pair of the door panels 102, 104, 106 and a mating recess/groove can be provided in the exterior edge surface (e.g., bottom edge surface) of a second one of the immediately adjacent pair of the door panels 102, 104, 106.

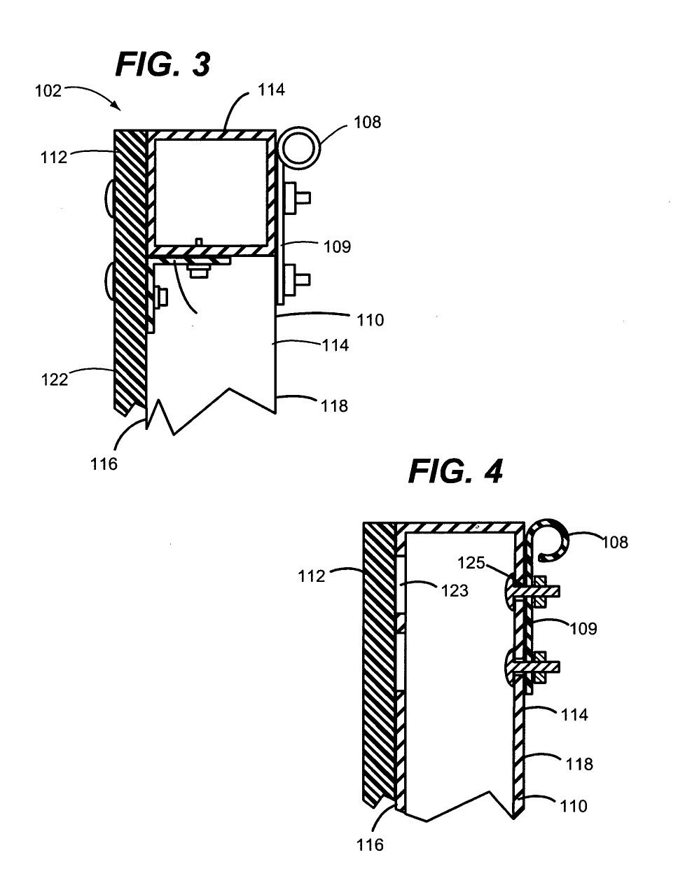

As shown in FIG. 4, optionally, fasteners that extend fully through the front plate 112, hinge arms 109 and frame 100 (i.e., hinge assembly retaining fasteners) can be omitted when the front plate 112 is secured to the frame 110 by the plate securing brackets 124 and associated fasteners. For example, the hinge assemblies 108 can be secured to the frame 110 by fasteners that are threaded into the frame, by fasteners that have their head within an interior space of a tube 114 of the frame 110, by welding the hinge arm 109 to the frame 110 or other suitable means for securing the hinge to the frame without requiring an associated fastener to extend through the front plate 112. As shown in FIG. 4, tubes 114 of the frame 110 have first clearance holes 123 through which the entire hinge assembly retaining fastener passes. In a wall opposite the first clearance hole 123, a second clearance hole 125 is provided. The second clearance hole 125 is sized to allow a shank of the threaded fastener to pass therethrough, but not a head of the threaded fastener. Accordingly, the shank of the threaded fastener can be passed through the second clearance hole from within the tune 114, thereby precluding threaded fasteners from extending through the front plate 112. In this manner, no fasteners need to extend through the front plate 112.

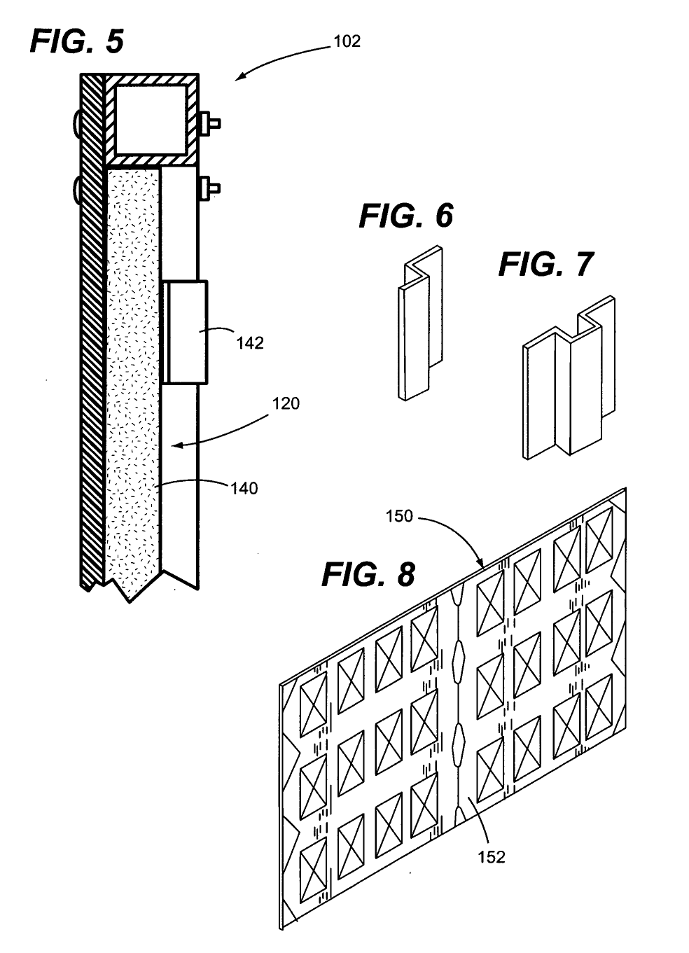

As shown in FIG. 5, a door panel configured in accordance with the present invention (e.g., door panel 102) can include a layer 140 of insulating material within each opening 120 of the door panel. Providing a layer 140 of insulating material in each opening 120 of the door panel serves to provide the door panel 102 with enhanced thermal and acoustical insulating properties. The insulation material can be held in place by one or more insulation brackets 142 that are secured to frame tubes defining an opening 120 in which the layer of insulating material is disposed. The insulation brackets 142 can be configured to be attached to the frame tubes by means such as, for example, compression fit, threaded fasteners, or the like. A first configuration of insulation bracket is shown in FIG. 6 and a second configuration of insulation bracket is shown in FIG. 7.

Referring now to FIG. 8, a one-piece aggregate door panel 150 is shown. The front plate 112 of each one of the door panels 102, 104, 106 is a segment from the aggregate door plate 150 (e.g., segments of a door plate that is about 16 feet wide by about 7 feet tall). More specifically, the front plate 112 of adjacent ones of the door panels 102, 104, 106 are adjacent segments of the aggregate door plate 150. In this manner, the aggregate door plate 150 can be formed in a manner whereby it includes a design or other type of visual component on its front surface 152 (e.g., integrally molded, extruded, etc) and can be segmented via cutting or the like to produce the individual door plates 112 for teach of the door panels 102, 104, 106. Preferably, but not necessarily, the door plate is made from a polymeric material (e.g., vinyl) and can have of thickness of between about one-eighth inch and about one-half inch. Optionally, a front plate in accordance with the present invention can be made from other materials such as, for example, wood, metal, composite and/or laminate materials. In the case where discretely attached adornments are required to be attached to the front surface of a front plate, the front plate being made from a polymeric material such as vinyl would provide for a secure sub-structure to which such adornments can be attached via threaded fasteners, adhesive of the like.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A garage door panel, comprising:
a frame made from a plurality of tubes, wherein said tubes are adjoined in a manner providing the frame with a generally flat front surface and a generally flat rear surface and in a manner such that said tubes form at least one opening extending between said faces; and
a one-piece front plate mounted on the frame at the front surface thereof, wherein the front plate covers all of said at least one opening.

2. The garage door panel of claim 1, further comprising:
a plurality of front plate securing brackets each attached to a respective one of said tubes within said at least one opening, wherein each one of said brackets is engaged with the front plate.

3. The garage door panel of claim 2 wherein each one of said brackets is engaged with the front plate by at least one fasteners extending fully through a respective one of said brackets and into the front plate.

4. The garage door panel of claim 1, further comprising:
a plurality of fasteners each extending through the frame and the front plate, wherein each one of said fasteners extends through one of said tubes of the frame at a location adjacent one of an upper edge portion of the frame and a lower edge portion of the frame.

5. The garage door panel of claim 4, further comprising:
a plurality of front plate securing brackets each attached to a respective one of said tubes within said at least one opening, wherein each one of said brackets is engaged with the front plate;
a plurality of hinge assemblies each including a first hinge arm and a second hinge arm pivotably attached to the first hinge arm, wherein the first hinge arm of each one of said hinge assemblies is engaged with the rear surface of the frame at an upper edge portion thereof; and
a fasteners extending through each one of said hinge assemblies, the frame and the front plate.

6. The garage door panel of claim 5 wherein:
each one of said brackets is engaged with the front plate by at least one fasteners extending fully through a respective one of said brackets and into the front plate; and
the front plate extends substantially beyond one of a top edge face of the frame and a bottom edge face of the frame.

7. A garage door panel, comprising:
a frame made from a plurality of metal tubes, wherein said metal tubes each have a rectangular cross-sectional shape and wherein said tubes are adjoined in a manner providing the frame with a generally flat front surface and a generally flat rear surface and in a manner such that said tubes form a plurality of openings extending between said faces; and
a one-piece front plate mounted on the frame at the front surface thereof, wherein the front plate covers all of said openings and wherein the front plate is made from a sheet of polymeric material and wherein the front plate extends substantially beyond one of a top edge face of the frame and a bottom edge face of the frame.

8. The garage door panel of claim 7, further comprising:
a plurality of front plate securing brackets each attached to a respective one of said tubes within said at least one opening, wherein each one of said brackets is engaged with the front plate.

9. The garage door panel of claim 8 wherein each one of said brackets is engaged with the front plate by at least one fasteners extending fully through a respective one of said brackets and into the front plate.

10. The garage door panel of claim 7, further comprising:
a plurality of hinge assemblies each including a first hinge arm and a second hinge arm pivotably attached to the first hinge arm, wherein the first hinge arm of each one of said hinge assemblies is engaged with the rear surface of the frame at an upper edge portion thereof; and
a fasteners extending through each one of said hinge assemblies, the frame and the front plate.

11. The garage door panel of claim 10, further comprising:
a plurality of front plate securing brackets each attached to a respective one of said tubes within said at least one opening, wherein each one of said brackets is engaged with the front plate.

12. The garage door panel of claim 11 wherein each one of said brackets is engaged with the front plate by at least one fasteners extending fully through a respective one of said brackets and into the front plate.

13. A garage door, comprising:
a plurality of door panels pivotably attached to each other in a manner allowing articulation of each one of said door panels with respect to an immediately adjacent other one of said door panels, wherein each one of said door panels comprises:
a frame made from a plurality of tubes, wherein said tubes are adjoined in a manner providing the frame with a generally flat front surface and a generally flat rear surface and in a manner such that said tubes form a at least one opening extending between said faces; and
a one-piece front plate mounted on the frame at the front surface thereof, wherein the front plate covers all of said at least one opening.

14. The garage door of claim 13 wherein:
the front plate, of each one of said door panels is a segment from a one-piece aggregate door plate;
front plates of adjacent ones of said door plates are adjacent segments of the aggregate door plate; and
the front plate of at least one of said door plates extends substantially beyond one of a top edge face of the frame to which the front plate is mounted and a bottom edge face of the frame to which the front plate is mounted.

15. The garage door of claim 14 wherein:
each one of said door plates further comprises a plurality of plate securing brackets each attached to a respective one of said tubes within said at least one opening thereof; and
each one of said brackets is engaged with the front plate of the door plate to which said bracket is attached.

16. The garage door of claim 15, further comprising:
a plurality of hinge assemblies each including a first hinge arm and a second hinge arm pivotably attached to the first hinge arm, wherein immediately adjacent ones of said door panels has at least two of said hinge assemblies coupled therebetween such that the first hinge arm of said coupled hinge assemblies is engaged with the rear surface of the frame of a first immediately adjacent one of said door panels and the second hinge arm of said coupled hinge assemblies is engaged with the rear surface of the frame of a second immediately adjacent one of said door panels; and
a fasteners extending through each one of said hinge arms, the engaged one of said frames and the front plate mounted on the engaged one of said frames.

17. The garage door of claim 16 wherein each one of said brackets is engaged with the panel by a plurality of threaded fasteners extending fully through a respective one of said brackets and into the front plate of the door panel including said bracket.

18. The garage door of claim 13, further comprising:
a plurality of hinge assemblies each including a first hinge arm and a second hinge arm pivotably attached to the first hinge arm, wherein immediately adjacent ones of said door panels has at least two of said hinge assemblies coupled therebetween such that the first hinge arm of said coupled hinge assemblies is engaged with the rear surface of the frame of a first immediately adjacent one of said door panels and the second hinge arm of said coupled hinge assemblies is engaged with the rear surface of the frame of a second immediately adjacent one of said door panels; and
a fasteners extending through each one of said hinge arms, the engaged one of said frames and the front plate mounted on the engaged one of said frames.

19. The garage door of claim 18 wherein:
each one of said door panels further comprises a plurality of plate securing brackets each attached to a respective one of said tubes within said at least one opening thereof;
each one of said brackets is engaged with the front plate of the door panel to which said bracket is attached; and
the front plate of at least one of said door panels extends substantially beyond one of a top edge face of the frame to which the front plate is mounted and a bottom edge face of the frame to which the front plate is mounted.

20. The garage door of claim 19 wherein each one of said brackets is engaged with the panel by a plurality of threaded fasteners extending fully through a respective one of said brackets and into the front plate of the door panel including said bracket.
